(19) United States
(12) Patent Application Publication
(10) Pub. No.: US 2026/0310447 A1
(43) Pub. Date: Oct. 8, 2026

(54) METHOD FOR UPDATING AT LEAST ONE PROGRAM OF FIRMWARE OF A PROTECTION OR AUTOMATION SYSTEM IN THE FIELD OF ELECTRICAL ENERGY TRANSMISSION AND DISTRIBUTION

(71) Applicant: Siemens Aktiengesellschaft, München (DE)

(72) Inventors: Karsten Becker, Berlin (DE); Jonas Hurrelmann, Berlin (DE); Roland Kind, Berlin (DE); Kai Koplin, Berlin (DE); Christoph Lerzer, Nürnberg (DE); Dirk Sommer, Berlin (DE); Marcus Stollfuss, Berlin (DE); Klaus Polster, Nürnberg (DE); Kilian Telschig, Garching (DE); Frank Wigger, Nürnberg (DE)

(21) Appl. No.: 19/483,320

(22) PCT Filed: May 3, 2024
(86) PCT No.: PCT/EP2024/062293

§ 371 Date: Nov. 11, 2025

(30) Foreign Application Priority Data
May 11, 2023 (EP) 23172800.7

(51) Int. Cl. G06F 8/656; G06F 9/455; G06F 9/54

(52) U.S. Cl. CPC G06F 8/656; G06F 9/45558; G06F 9/546; G06F 2009/4557; G06F 2009/45575

(57) ABSTRACT

A method of updating at least one program of firmware in a protection or automation system in the field of electrical energy transmission or distribution. In addition to the program to be updated that is currently operating, an updated version or configuration of the program is launched as a new instance. The new instance informs an update program with a first status message that it is ready to transfer operation from the program to be updated to itself. The program to be updated then transmits operating data and parameters to the new instance. The new instance communicates by a second status message and the program to be updated communicates by a third status message that they are ready to change over operation to the new instance. Then operation is changed over from the program to be updated to the new instance.

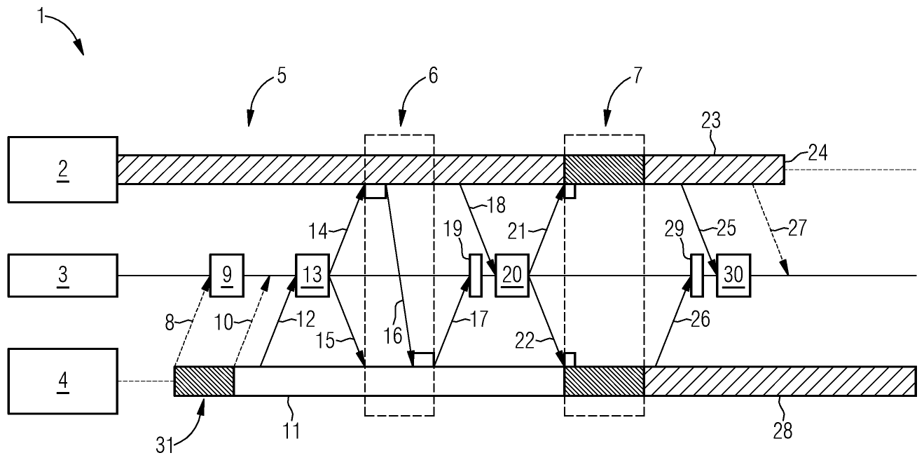

In the field of electrical energy transmission and distribution, substations are used to raise or lower the network voltage prevailing in the supply network. In addition to at least one transformer, substations have switching units that, after receiving a switching signal, disconnect conductor outgoers of the substation from the rest of the supply network. Said switching signals are generated by protection and automation systems that are used to monitor the current and voltage characteristics in the conductors of the substation for the presence of fault conditions. If there is a fault condition, a switching signal is generated and transmitted to one or more selected switching units so that selected switching units are transferred into their interrupter position. In the interrupter position, the contacts of the selected switching unit are separated from one another. A flow of current via the contacts of the switching unit is therefore prevented. A conductor run connected to one contact of said switching unit is then disconnected from the rest of the supply network, which is connected to the other contact of said circuit breaker.

Protection and automation systems of a substation have programs stored by the manufacturer, which in this case are referred to as firmware. The firmware or the configuration thereof need to update from time to time. According to a previous, widely used procedure, operation of the protection and automation systems is interrupted for an update of the firmware that has become necessary. The new programs are then transferred. The protection and automation system may resume its operation with the new firmware. This procedure has the disadvantage that operation of the system to be updated has to be interrupted.

In the case of another procedure that is known to a person skilled in the art, protection and automation systems are of redundant design, that is to say provided in duplicate. It is obvious that this procedure entails increased costs.

The object of the invention is therefore to provide a method for updating the firmware of a protection and automation system, using which it is possible to update the firmware or the configuration thereof at lower costs without having to interrupt operation of a system provided with the firmware.

The invention achieves this object by a method for updating at least one program of firmware of a protection or automation system in the field of electrical energy transmission or distribution, in which, in addition to the program that is in operation and that is to be updated, an updated version or configuration of the program to be updated is started as a new instance, the new instance communicates, as a first status message, to an update program that it is ready to transfer operation from the program to be updated to itself at the beginning of the takeover process, operating data and parameters of the program to be updated are then transferred to the new instance, the new instance communicates, by means of a second status message, and the program to be updated communicates, with a third status message, that they are ready to switch over operation to the new instance, and operation is then taken over by the new instance.

According to the invention, provision is made for an instance of the updated program to be started during ongoing operation of the programs of the firmware. Within the scope of the invention, the update is accompanied by an update program, wherein the update program has application software that has no relevance at all to the system. The application software is also referred to as an application program, which is shortened to app. The program to be updated, the new instance and the update program are configured to exchange data with one another.

First, a status message is transmitted from the new instance to the update program. In this way, it is communicated to the update program that the new instance is ready to take over operation. However, for this purpose, the new instance requires a bundle of data such as, for example, the position of the assigned switches, the time standard with which the protection system, for which the new instance is intended to be used, has synchronized, recently obtained measured values, or the like. The new instance has to obtain this data bundle from the program to be updated so that it may continue operation of the protection system seamlessly.

The update program therefore communicates to the program to be updated that the new instance is ready to take over the data bundle, and furthermore instructs the program to be updated to transmit said bundle of data to the new instance.

Following transmission of the data, the program to be updated communicates to the update program that said data bundle has been transmitted and that it is ready to switch over operation to the new instance.

After the new instance has obtained said data bundle, it communicates, by way of status messages, to the update program that it has obtained the requested data and is now ready to switch over. If the update program has obtained said status messages, it initiates the switchover of operation by sending corresponding data telegrams to the program to be updated or to the new instance. Operation is switched over to the new instance, which is then stored in a memory of the protection and automation system during ongoing operation. Operation is then continued by the new instance, that is to say with the present version of the program.

The invention therefore allows an interruption-free update of a program of the firmware of a protection and automation system during ongoing operation of the protection system. Advantageously, all of the status messages are transmitted to the update program and the switchover of operation is initiated by the update program. This establishes a division of tasks that has proven to be expedient.

In one variant of the method according to the invention, the program to be updated continues its operation over a transitional duration or a transitional period following the switchover to the new instance. Should disturbances occur with the new instance, it is therefore possible to switch back to the program to be updated without any problems. In other words, this is a safety measure.

Further advantages result if the new instance and the program to be updated communicate, by means of status messages, to the update program that they are in normal operation or have stopped operation. After receiving this information or status messages, the update program has fulfilled its purpose and may also be ended.

Using a preferred configuration of the invention, the program to be updated and the new instance each run in a container. Running programs in containers is known to a person skilled in the art, and thus a more detailed description of programs in containers may be dispensed with. Within the scope of the invention, advantages result from a runtime environment isolated from other processes and programs.

As already explained, the program to be updated and the new instance and the application software are configured to exchange data with one another.

The invention is explained in more detail below on the basis of an exemplary embodiment with reference to the appended figure, wherein the

figure illustrates the sequence of an exemplary embodiment of the method according to the invention.

The figure schematically illustrates the sequence of the method 1 according to the invention on the basis of a bar diagram. The program to be updated is designated by the reference sign 2. The new instance of an updated version of the program bears the reference sign 4, wherein an update program is designated by the reference sign 3. The lengths of the bars extending horizontally from left to right in the figure are intended to illustrate the time during which the respective program is active.

During the period 5, the program 2 to be updated is in normal operation. The switchover to the new instance 4 is initiated over a period that is designated by a rectangle 6 crossing the horizontal bars at right angles. The vertical triangle 7 represents the period during which operation switches over from the program 2 to be updated to the new instance 4.

First, the new instance 4 is started. This start is communicated to the update program 3 by way of a status message 8. The communication 8 triggers a new status 9 in the update program. At the end of an initialization phase 31, the new instance 4 communicates, by way of a status communication 10, to the update program 3 that it is in its observation state. The observation period is designated by the reference sign 11 in the figure.

Using a further status message 12, the new instance communicates to the update program 3 that it is ready to take over operation. The update program 3 is therefore transferred into a new state 13. In the new state 13, the update program 3 issues two messages 14 and 15, which are transmitted to the program 2 to be updated, on the one hand, and to the new instance 4, on the other hand. A transfer of data 16 from the program 2 to be updated to the new instance 4 is triggered by way of the status message 14. In this case, a predetermined data bundle is transferred, which comprises, for example, the present switch positions, a time standard with which the protection or automation system has synchronized, the most recently obtained current or voltage values, or the like.

Following this data transfer, which is carried out during the preparation period 6, the new instance 4 communicates, by way of the status message 17, to the update program 3 that it is ready for the switchover. A corresponding readiness message 18 is also effected by the program to be updated. This triggers the states 19 and 20 into which the update program 3 is transferred by means of said readiness messages 17, 18.

If they have both issued their readiness messages 17, 18, wherein the order is insignificant, the update program 4 triggers the switchover by way of corresponding instruction messages 21 and 22. Operation is switched to the new instance 4 during the switchover period 7. Following the switchover, the program 2 to be updated continues to run for a while over the period 23 before it is finally switched off at the time 24.

Before this, the program 2 to be updated communicated, using the message 27, to the update program 3 that it is about to end. The status message 26 that is transmitted from the new instance to the update program 3 is effected as soon as the new instance 4 has taken over operation and has established that it is running under normal operating conditions. As the last status message 27, the program 2 to be updated transmits. This is a communication to the update program 3 with the content that the program to be updated is ending its operation.

This allows an interruption-free update of programs of firmware.

1-7. (canceled)

8. A method for updating firmware, the method comprising:
providing the firmware of a protection or automation system in the field of electrical energy transmission or distribution, the firmware having at least one program to be updated;
in addition to the at least one program that is in operation and that is to be updated, starting an updated version or configuration of the program as a new instance;
communicating by the new instance, with a first status message to an update program that the new instance is ready to transfer operation from the program to be updated to itself;
transferring, by the program to be updated, operating data and parameters to the new instance;
communicating by the new instance, with a second status message, and communicating by the program to be updated, with a third status message, that the new instance and the program to be updated are ready to switch over operation to the new instance; and
switching over operation from the program to be updated to the new instance.

9. The method according to claim 8, which comprises transmitting the first, second, and third status messages to the update program and initiating the switching over of operation by the update program.

10. The method according to claim 9, which comprises remaining the program to be updated active for a transitional period after the switching over of operation.

11. The method according to claim 8, which comprises communicating by the new instance and by the program to be updated, with a fourth and a fifth status message respectively, to the update program that they have taken over or given up operation.

12. The method according to claim 8, which comprises running each of the program to be updated and the new instance in a container.

13. The method according to claim 12, which comprises running the update program in a container.

14. The method according to claim 8, which comprises running the update program in a container.

15. The method according to claim 8, wherein the program to be updated, the new instance, and the update program are configured to exchange data with one another.
